(19) United States
(12) Patent Application Publication
(10) Pub. No.: US 2026/0097790 A1
(43) Pub. Date: Apr. 9, 2026

(54) CONTROL APPARATUS OF VEHICLE

(71) Applicant: ISUZU MOTORS LIMITED, Yokohama-shi (JP)

(72) Inventor: Hideyuki HARA, Mountain View, CA (US)

(21) Appl. No.: 19/351,589

(22) Filed: Oct. 7, 2025

Related U.S. Application Data
(60) Provisional application No. 63/705,132, filed on Oct. 9, 2024.

(30) Foreign Application Priority Data
Jan. 29, 2025 (JP) 2025-012996

(51) Int. Cl. B60W 60/00; B60W 10/18; B60W 10/20; B60W 30/09; B60W 30/095; B60W 50/00

(52) U.S. Cl. CPC B60W 60/0011; B60W 10/18; B60W 10/20; B60W 30/09; B60W 30/0956; B60W 50/0097; B60W 60/0015; B60W 2050/0031; B60W 2520/105; B60W 2520/14; B60W 2554/4044

(57) ABSTRACT

The present disclosure relates to a control apparatus of a vehicle that automatically travels along a predetermined target route, the control apparatus comprising: a trajectory plan determination unit configured to determine which trajectory plan to adopt as a future travel trajectory of the vehicle between a target route maintenance trajectory, a left avoidance trajectory, and a right avoidance trajectory; a motion plan determination unit configured to determine which motion plan to adopt as a future motion mode of the vehicle between a normal motion according to the determined trajectory plan or an emergency evacuation motion; and a vehicle control unit configured to control the vehicle such that the driving state of the vehicle at each future time point is in accordance with the determined motion plan, wherein the update frequency of the motion plan determination unit is higher than the update frequency of the trajectory plan determination unit.

### TECHNICAL FIELD

The present disclosure relates to a control apparatus of a vehicle.

### BACKGROUND ART

In recent years, the development of ADAS (Advanced Driver Assistance System) and the autonomous driving related technologies for automobiles has progressed rapidly. For example, the adaptive cruise control, the lane keep assist system, the automatic emergency braking, etc., which are functions that an automate part of the driving operation, have been put into practical use.

### CITATION LIST

### Patent Literature

PTL 1: Japanese Patent Application Laid-Open No. 2018-62261

### Non-Patent Literature

NPTL 1: Keisuke Yoneda, et al. “Trajectory optimization and state selection for urban automated driving”, Artificial Life and Robotics, Volume 23, pages 474-480, (2018), Published: 22 Sep. 2018

NPTL 2: Pedro Bautista-Camino, et al. “Local Path Planning for Autonomous Vehicles Based on the Natural Behavior of the Biological Action-Perception Motion”, Energies 2022, 15(5), 1769, Published: 27 Feb. 2022.

NPTL 3: D. Fox, et al. “The dynamic window approach to collision avoidance”, IEEE Robotics & Automation Magazine, Volume 4, Issue 1, Page 23-33, Published: 6 Aug. 2002

### SUMMARY OF INVENTION

### Technical Problem

Incidentally, in this type of the autonomous driving-related technology, a control system has been developed that acquires object information around the vehicle, generates a trajectory plan for the vehicle based on the acquired object information and map information, and automatically drives the vehicle to follow that plan (see, for example, PTL 1).

However, in the vehicle control apparatus of the related art such as PTL 1, the calculation time for generating the trajectory plan is long, and it may be difficult to avoid danger when unforeseen risks arise during trajectory planning. Additionally, the computational load for trajectory planning and trajectory-following control is high, making it difficult to update the vehicle motion command values at the high frequency required for autonomous driving.

The present invention has been made in view of the above problems, and an object of the present invention is to provide a control apparatus of a vehicle capable of robust vehicle control that can address unforeseen risks during trajectory planning.

### Solution to Problem

A main aspect of the present disclosure for solving the above-mentioned problems is a control apparatus of a vehicle that automatically travels along a predetermined target route, the control apparatus comprising:
a trajectory plan determination unit configured to determine, based on surrounding information of the vehicle, which trajectory plan to adopt as a future travel trajectory of the vehicle between a target route maintenance trajectory, a left avoidance trajectory, and a right avoidance trajectory;
a motion plan determination unit configured to determine, based on the surrounding information, which motion plan to adopt as a future motion mode of the vehicle between a normal motion according to the determined trajectory plan or an emergency evacuation motion that temporarily disables the trajectory plan; and
a vehicle control unit configured to control the vehicle based on the motion plan and current driving state information of the vehicle such that the driving state of the vehicle at each future time point is in accordance with the determined motion plan,
wherein the trajectory plan determination unit and the motion plan determination unit sequentially update the trajectory plan and the motion plan, respectively, and the update frequency of the motion plan determination unit is higher than the update frequency of the trajectory plan determination unit.

### Advantageous Effects of Invention

The vehicle control apparatus according to the present invention is capable of robust vehicle control that can address unforeseen risks during trajectory planning. In addition, it can reduce the computational load of the control system for the autonomous vehicle driving, and can perform vehicle motion control more frequently.

### BRIEF DESCRIPTION OF DRAWINGS

FIG. 1 is a diagram showing the configuration of a vehicle.

FIG. 2 is a block diagram showing the functional configuration of a control apparatus.

FIG. 3 is a diagram showing an example of a movement mode of the vehicle that automatically travels along a predetermined target route set as a travel schedule.

FIG. 4A is a diagram for explaining a trajectory plan determined by a trajectory plan determination unit. FIG. 4B is a diagram explaining a motion plan determined by a motion plan determination unit.

FIG. 5 is a flowchart showing an example of an operation content of the trajectory plan determination unit.

FIG. 6 is a flowchart showing an example of an operation content of the motion plan determination unit.

### DESCRIPTION OF EMBODIMENTS

Hereinafter, a preferred embodiment of the present invention will be described in detail with reference to the accompanying drawings. Note that, in the present specification and drawings, components having substantially the same functions are denoted by the same reference signs, and redundant descriptions are omitted thereby.

### Vehicle Configuration

First, an example of the configuration of a vehicle according to one embodiment of the present invention (hereinafter referred to as “vehicle 1”) will be described. Note that vehicle 1 according to this embodiment is a vehicle equipped with a control apparatus capable of performing autonomous driving.

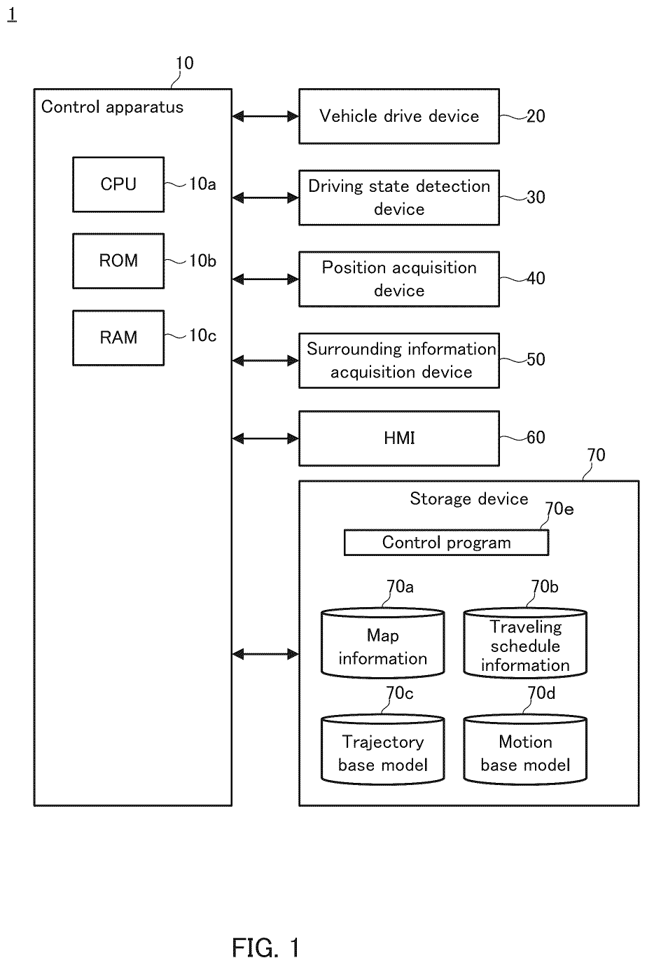

FIG. 1 is a diagram showing the configuration of vehicle 1.

Vehicle 1 is equipped with, for example, vehicle drive device 20, driving state detection device 30, position acquisition device 40, surrounding information acquisition device 50, HMI (Human Machine Interface) 60, storage device 70, and a control apparatus 10.

Vehicle drive device 20 is a drive unit that drives vehicle 1, and includes, for example, a drive motor, a power transmission mechanism, a brake device, and a steering device. Vehicle drive device 20 generates power using, for example, a drive motor, and transmits the power to wheels via a power transmission mechanism (such as a propeller shaft, a differential gear, and a drive shaft) to drive vehicle 1. The operation of vehicle drive device 20 is controlled by control apparatus 10.

Driving state detection device 30 includes various sensors that detect the driving state of vehicle 1. Driving state detection device 30 includes, for example, an accelerator opening sensor that detects an accelerator opening, a steering angle sensor that detects a steering angle of a steering device, an acceleration sensor that detects acceleration acting in the front-rear direction of vehicle 1, a torque sensor that detects torque acting on a power transmission mechanism between the wheels and the engine of vehicle 1, and a vehicle speed sensor that detects the vehicle speed of vehicle 1.

Position acquisition device 40 detects the current position of vehicle 1. Position acquisition device 40 has, for example, a GPS antenna that periodically receives GPS signals from a plurality of GPS satellites, measures the current position of vehicle 1 from the GPS signals, and transmits the position information of vehicle 1 to control apparatus 10.

Position acquisition device 40 may detect the current position of vehicle 1 as a relative position with respect to objects around vehicle 1. In this case, position acquisition device 40 may be configured with an on-board camera, an infrared sensor, a sonar, a radar, or the like.

Surrounding information acquisition device 50 is a sensor that detects the positions of objects present around vehicle 1, and is configured to include, for example, an in-vehicle camera, an infrared sensor, a sonar, a radar, etc. Surrounding information acquisition device 50 is disposed, for example, at each of the four corners of vehicle 1 so as to be able to detect objects in each direction around vehicle 1. Surrounding information acquisition device 50 outputs the surrounding object information (hereinafter also referred to as “surrounding information”) of vehicle 1 that it detects to control apparatus 10.

More preferably, both the radar and the on-board camera are used as surrounding information acquisition device 50. The on-board camera can be preferably used to grasp the two-dimensional position of a surrounding object, while the radar can be preferably used to accurately detect the distance to the surrounding object.

The surrounding object information acquired by surrounding information acquisition device 50 includes, for example, attribute information of pedestrians, bicycles, vehicles, etc., as well as their current positions and current speed vectors.

HMI 60 is a user interface, such as a touch panel or a keyboard, that accepts input operations from a user (hereinafter, abbreviated as “user”) riding in vehicle 1. HMI 60 is configured to be capable of accepting input operations, such as an execution command when executing autonomous driving.

Storage device 70 is, for example, an auxiliary storage device such as a HDD, an SSD, or a USB memory. Storage device 70 stores, for example, control program 70e for automatically driving vehicle 1, as well as data such as map information 70a, traveling schedule information 70b, Trajectory base model 70c, and motion base model 70d.

Map information 70a is, for example, a database of map data that stores road maps in association with the coordinates of the road maps. The road maps in map information 70a include road information such as the positions of intersections, the positions of traffic lights, and the number of lanes. The coordinates of the road maps are set based on, for example, latitude and longitude or a predetermined position (for example, an intersection around vehicle 1).

Map information 70a is referred to, for example, to identify a target route to be followed when vehicle 1 is driven automatically, or to identify a reference route to be used when changing lanes from the current driving lane.

Traveling schedule information 70b is, for example, information related to a target route from a travel start point to a travel target point that is set when vehicle 1 starts traveling. The target route of traveling schedule information 70b is stored, for example, in association with the road map of map information 70a and specifies a target position on the road map to which vehicle 1 should travel at each point during traveling. In addition, when the travel route has multiple lanes, the target route also includes settings such as which lane vehicle 1 should travel on. In addition, the target route of traveling schedule information 70b is stored, for example, in association with a legal speed or the like under road regulations as a target vehicle speed under normal circumstances (hereinafter referred to as a “scheduled set vehicle speed”).

Traveling schedule information 70b is generated, for example, by the traveling schedule generating function of control apparatus 10 based on the driving start point and the driving destination point input by the user. The traveling schedule generating function is a known technology, so a description thereof will be omitted here. Traveling schedule information 70b may also be obtained through communication circuits from a travel schedule generated by an external device (not shown).

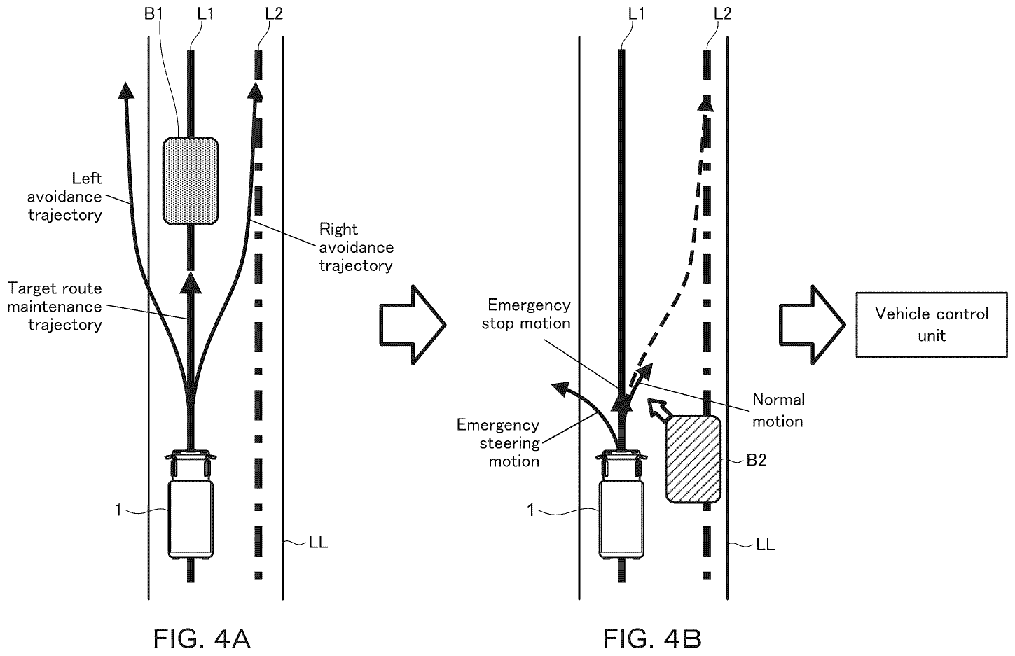

Trajectory base model 70c is model data used to generate a trajectory plan of vehicle 1, which is referred to by trajectory plan determination unit 11 of control apparatus 10 (described later). As Trajectory base model 70c, for example, trajectory base models related to a target route maintaining trajectory, a left avoidance trajectory, and a right avoidance trajectory are stored (see FIG. 4).

Motion base model 70d is model data used to generate a motion plan of vehicle 1, which is referred to by motion plan determination unit 12 of control apparatus 10 described later. As motion base model 70d, for example, a motion base model related to a normal motion according to a trajectory plan or an emergency evacuation motion (here, an emergency stop motion or an emergency steering avoidance motion) that temporarily disables the determined trajectory plan are stored (see FIG. 4).

Incidentally, a part or all of the data stored in storage device 70 may be stored in ROM 10b of control apparatus 10 or the like.

Control apparatus 10 is an electronic control unit that controls each part of vehicle 1. Control apparatus 10 controls each part of vehicle drive device 20 (e.g., the output of a drive motor, the engagement and disengagement of a clutch, the gear stage of a automatic transmission, and the steering angle of a steering device) while referring to sensor information from driving state detection device 30 so as to optimize the driving condition of vehicle 1. Control apparatus 10 is configured to control vehicle drive device 20 so as to execute automatic driving of vehicle 1 (meaning autonomous driving; the same applies below).

Control apparatus 10 includes, for example, CPU 10a, ROM 10b, RAM 10c, an input port (not shown), and an output port (not shown). CPU 10a of control apparatus 10 reads a program corresponding to the processing contents from ROM 10b or storage device 70, loads it in RAM 10b, and centrally controls the operation of each block in cooperation with the loaded program. At this time, various data stored in storage device 70 is referenced.

In addition, control apparatus 10 is connected to vehicle drive device 20, driving state detection device 30, position acquisition device 40, surrounding information acquisition device 50, HMI 60, and Storage device 70 via an in-vehicle network (e.g., a communication network conforming to the CAN communication protocol) and is capable of sending and receiving necessary data and control signals to and from each other.

### Configuration of the Vehicle Control Apparatus

Next, the configuration of control apparatus 10 according to this embodiment will be described. Here, only the configuration for allowing vehicle 1 to automatically travel along a predetermined target route set as a traveling schedule while avoiding surrounding objects present at each point will be described.

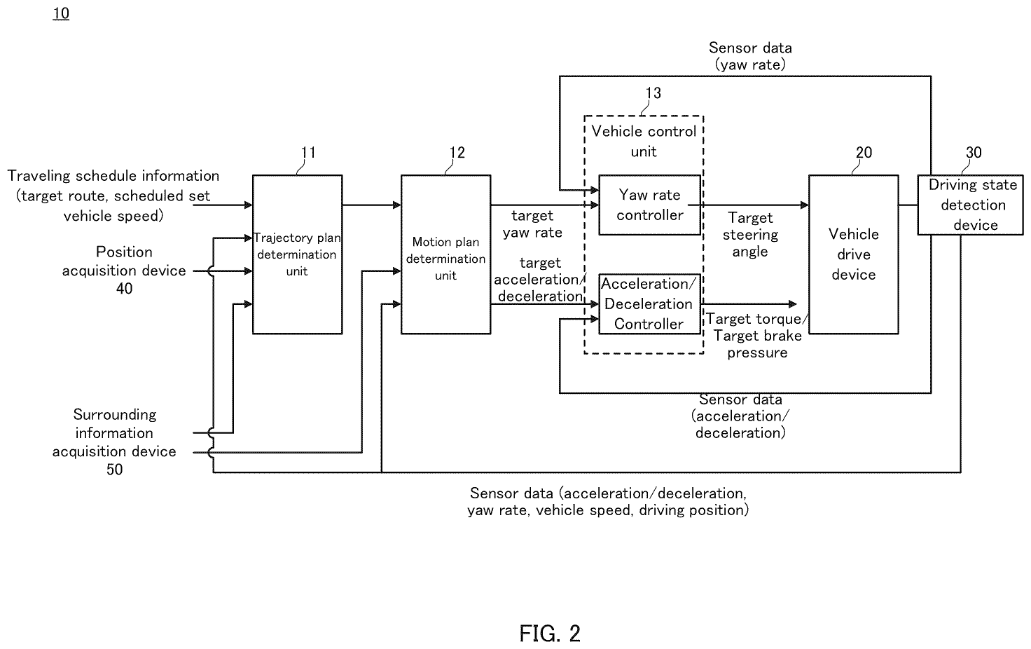

FIG. 2 is a block diagram showing the functional configuration of control apparatus 10. Note that the arrows in FIG. 2 represent signal transmission paths.

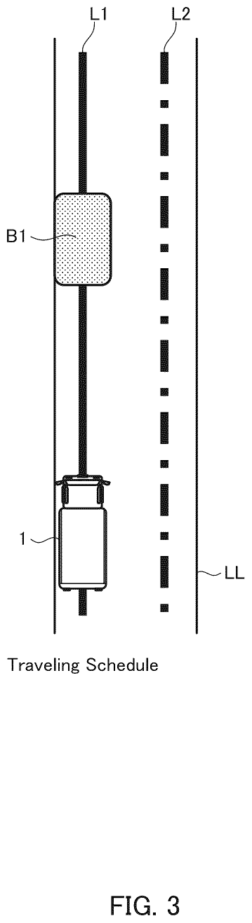

FIG. 3 is a diagram showing an example of a movement mode of vehicle 1 that automatically travels along the predetermined target route set as the traveling schedule.

FIG. 4 is a diagram for explaining a trajectory plan (FIG. 4A) determined by trajectory plan determination unit 11 and a motion plan (FIG. 4B) determined by motion plan determination unit 12.

Control apparatus 10 has the functions of trajectory plan determination unit 11, motion plan determination unit 12, and vehicle control unit 13 to enable the automatic travel of vehicle 1.

As described above, vehicle 1 according to this embodiment is configured to automatically travel along the predetermined target route set as the traveling schedule under the control of control apparatus 10. However, when vehicle 1 is actually travelling, various obstacles exist on the travel route as shown in FIG. 3, and therefore control apparatus 10 needs to drive vehicle 1 while avoiding such obstacles. Examples of such obstacles include pedestrians, other vehicles, and objects that have fallen on the travel route.

In FIG. 3, LL represents the road on which vehicle 1 is traveling (e.g., a two-lane road), L1 represents the target route, L2 represents other possible routes on a road adjacent to the target route (e.g., a lane different from the lane of target route L1), and B1 represents an obstacle present on the target route (e.g., another vehicle in stopping on the road).

Trajectory plan determination unit 11 is a function for stably driving vehicle 1 along the target route while avoiding such obstacles based on the surrounding object information of vehicle 1. That is, under a situation such as that shown in FIG. 4A, trajectory plan determination unit 11 generates a trajectory plan that avoids such obstacles.

In FIG. 4A, to avoid the detected obstacle B1 in front of the travel route (i.e., target route L1), trajectory plan determination unit 11 generates a trajectory plan (i.e., right avoidance trajectory) to change lanes from the target route L1 to another travelable route L2 adjacent to the right side of the target route (e.g., a lane different from the target route L1).

Here, trajectory plan determination unit 11 receives inputs of the driving state information of vehicle 1 (i.e., representing information from driving state detection device 30), the current position information of vehicle 1 (i.e., representing information from position acquisition device 40), and the surrounding object information of vehicle 1 (i.e., representing information from surrounding information acquisition device 50), which are sequentially detected. Then, based on these information, the information related to the travel schedule (here, the target route and scheduled set speed) 70b, map information 70a, and Trajectory base model 70c of each mode, trajectory plan determination unit 11 generates a trajectory plan (hereinafter abbreviated as “trajectory plan”) as a future travel trajectory of vehicle 1 from one time point ahead to a predetermined period ahead.

The “trajectory plan” is, for example, time-series data relating to the target running position and target vehicle speed of vehicle 1 at each future time point from one time ahead of the current time to a predetermined time ahead (for example, 10 seconds ahead) (for example, time-series points of the target running positions and target vehicle speeds at 100 points at 0.1 second intervals from one time ahead). In this embodiment, the trajectory plan set by trajectory plan determination unit 11 is not directly adopted as an instruction value for vehicle motion control, so in order to reduce the calculation load, it is desirable to generate the trajectory plan based on a future prediction of the vehicle position using a kinematics model, which has a low calculation load among vehicle motion base models.

Specifically, first, trajectory plan determination unit 11 determines which trajectory plan to adopt, the target route maintaining trajectory, the left avoidance trajectory, or the right avoidance trajectory, using a predetermined cost function based on the surrounding object information of vehicle 1. For example, in a situation where no obstacle is detected around (for example, ahead of) vehicle 1 in the surrounding object information, trajectory plan determination unit 11 selects the target route maintaining trajectory. On the other hand, for example, when an obstacle is detected around (for example, ahead of) vehicle 1 in the surrounding object information, trajectory plan determination unit 11 selects the left avoidance trajectory or the right avoidance trajectory as the trajectory plan. At this time, whether to adopt the left avoidance trajectory or the right avoidance trajectory depends on a travelable route that exists adjacent to the target route.

Here, the “target route maintaining trajectory” means a trajectory that travels on the target route, the “left avoidance trajectory” means a trajectory that changes lanes from the target route to a route that shifts the travel position to the left, and the “right avoidance trajectory” means a trajectory that changes lanes from the target route to a route that shifts the travel position to the right. These trajectory base model 70c are stored in storage device 70 in advance, and trajectory plan determination unit 11 generates a trajectory plan based on trajectory base model 70c.

For example, in the case of the “target route maintaining trajectory,” trajectory plan determination unit 11 generates a trajectory plan based on Trajectory base model 70c for the “target route maintaining trajectory,” so as to travel along the target route set as the traveling schedule at the scheduled set vehicle speed (e.g., a legal speed).

On the other hand, in the case of the “left avoidance trajectory” or the “right avoidance trajectory”, trajectory plan determination unit 11 refers to a travelable route that exists adjacent to the target route, and calculates a trajectory profile according to Trajectory base model 70c for the “left avoidance trajectory” or “right avoidance trajectory” such that the movement trajectory from the current position of vehicle 1 to the travelable route is appropriate. The trajectory profile set on Trajectory base model 70c is not particularly limited, but may be, for example, a trajectory that draws a spline curve from the current position to the target position. For example, if the “left avoidance trajectory” or the “right avoidance trajectory” is a lane change from the current position of vehicle 1, the movement trajectory is a spline curve that smoothly connects from the current position to the center line of the lane to be changed. The target vehicle speed at this time may be set to a value different from the scheduled set vehicle speed so that the lane change can be performed smoothly.

In addition, trajectory plan determination unit 11 may use, for example, a known Frenet Frame method (see NPTL 1) or a known Attractor Dynamic Approach method (see NPTL 2) as a method for calculating the trajectory profile of the trajectory plan.

In addition, the travelable route adjacent to the target route can be specified, for example, from map information 70a. As shown in FIG. 4A, on map information 70a, when the road of the driving road where vehicle 1 is traveling can be identified as having two lanes and the target route is set on one lane (e.g., left lane L1), the other lane (e.g., right lane L2) is identified as a travelable route. The road information (map information 70a) of the current position of vehicle 1 can be obtained through map matching with the current position of vehicle 1.

On the other hand, if the travel route along which vehicle 1 is traveling is not specified on map information 70a, the travelable route can also be specified from the surrounding object information from surrounding information acquisition device 50. Furthermore, in an off-road environment (i.e., when the travelable route is not specified on map information 70a and is not specified by the surrounding object information from surrounding information acquisition device 50), it is also possible to plan a new travelable route from the current vehicle position to the target arrival position without colliding with an obstacle, and set this route as the target route. Such route planning may be implemented at a lower frequency than the update frequency of trajectory planning.

Trajectory plan determination unit 11 sequentially updates the trajectory plan. The update frequency of the trajectory plan in trajectory plan determination unit 11 depends on the performance of CPU 10a of control apparatus 10, but is preferably 5 Hz or more, for example.

Moreover, until vehicle 1 passes the obstacle, trajectory plan determination unit 11 maintains and updates the trajectory plan related to the “left avoidance trajectory” or “right avoidance trajectory.” Then, when it is detected on the surrounding object information that vehicle 1 has passed the obstacle, trajectory plan determination unit 11 selects the “target route maintenance trajectory” as the trajectory plan. When returning vehicle 1 from the lane-changed position to the target route, trajectory plan determination unit 11 may use feedback control in vehicle control unit 13 (motion planning decision unit 12) to return to the target route, but it is desirable for trajectory plan determination unit 11 to generate a trajectory plan such that the movement trajectory from the lane-changed position to the target route forms a spline curve. In this case, for example, it is desirable that trajectory base model 70c for the “return trajectory” is prepared in advance and that trajectory plan determination unit 11 selects the “return trajectory” after the “left avoidance trajectory” or “right avoidance trajectory.”

As described above, the function of trajectory plan determination unit 11 makes it possible to stably drive vehicle 1 along the target route while avoiding obstacles. However, while vehicle 1 is actually traveling, as shown in FIG. 4B, there are also obstacles B2 that suddenly approach vehicle 1. In such a case, the calculation time required for generating the trajectory plan is long, and it may be difficult to avoid danger when a risk occurs that was not anticipated during the trajectory planning.

Motion plan determination unit 12 is a function that, when such an obstacle suddenly approaching vehicle 1 is detected, temporarily disables the trajectory plan generated by trajectory plan determination unit 11 and making vehicle 1 take an emergency evacuation motion. That is, motion plan determination unit 12 is capable of generating a motion plan to avoid a collision accident with such an obstacle and making vehicle 1 travel along the motion plan. FIG. 4B shows a situation where motion plan determination unit 12 generates a motion plan to make an emergency stop of vehicle 1 that is traveling along the right avoidance trajectory plan, in order to avoid obstacle B2 suddenly approaching vehicle 1.

Here, motion plan determination unit 12 receives inputs of the current driving state information of vehicle 1 (i.e., information from driving state detection device 30), the current position information of vehicle 1 (i.e., information from position acquisition device 40), and the surrounding object information of vehicle 1 (i.e., information from surrounding information acquisition device 50), which are sequentially detected, as well as the determined trajectory plan information from trajectory plan determination unit 11. Then, based on these pieces of information and motion base model 70d, motion plan determination unit 12 generates a motion plan (hereinafter, abbreviated as “motion plan”) as a future motion mode of vehicle 1 from one time ahead to a predetermined period ahead.

The “motion plan” is, for example, time-series data relating to the target acceleration/deceleration and target yaw rate of vehicle 1 at each future time point from one time ahead of the current time to a predetermined time ahead (for example, one second ahead) (for example, time-series points of the target acceleration/deceleration and target yaw rate at 10 points at 0.1 second intervals from one time ahead). Since the motion plan set by motion plan determination unit 12 is directly adopted as an instruction value for vehicle motion control, it is desirable to generate the motion plan based on a future prediction of the vehicle position using a dynamics model, which is a vehicle motion base model that is more detailed than a kinematics model.

Specifically, first, motion plan determination unit 12 uses a predetermined cost function based on information about objects surrounding vehicle 1 to determine whether to adopt a motion plan, either normal motion in accordance with the trajectory plan determined by trajectory plan determination unit 11, the emergency stop motion or the emergency steering avoidance motion. In the emergency stop motion or the emergency steering avoidance motion, the trajectory plan determined by trajectory plan determination unit 11 is temporarily disabled.

“Normal motion” refers to movement in accordance with the trajectory plan determined by trajectory plan determination unit 11, while “emergency stop motion or emergency steering avoidance movement” refers to temporarily disabling the trajectory plan and adopting a preset emergency evacuation motion. “Emergency stop motion” is a movement that slows down the target acceleration/deceleration on the current traveling trajectory and stops vehicle 1. On the other hand, “emergency steering avoidance motion” is motion that evacuates vehicle 1 to the opposite side of the approaching obstacle B2 when a sudden stop on the current driving trajectory may result in a collision with obstacle B2.

That is, motion plan determination unit 12 selects “normal motion” when the surrounding object information does not detect an obstacle rapidly approaching the surroundings of vehicle 1. In this case, motion plan determination unit 12 calculates a motion profile of the motion plan (i.e., a target acceleration/deceleration and a target yaw rate at each time point) based on the driving state information of vehicle 1 and the current position information of vehicle 1 so as to satisfy the target traveling position and the target vehicle speed of vehicle 1 at each time point set in the trajectory plan.

On the other hand, when an obstacle rapidly approaching the periphery of vehicle 1 is detected in the surrounding object information, motion plan determination unit 12 switches from “normal motion” to “emergency stop motion” or “emergency steering avoidance motion”. When motion plan determination unit 12 selects “emergency stop motion” as the motion plan, it sets a motion profile of the emergency stop motion based on motion base model 70d for the “emergency stop motion”. In the emergency stop motion, for example, a motion profile of deceleration until vehicle 1 is suddenly stopped without applying an excessive G value to the occupant is set based on the current vehicle speed as a reference.

Also, when motion plan determination unit 12 selects “emergency steering avoidance motion” as the motion plan, it sets a motion profile of the emergency steering avoidance motion based on motion base model 70d for the “emergency steering avoidance motion”. In the emergency steering avoidance motion, for example, a motion profile of steering avoidance is set so as to draw a spline curve to the left or right while decelerating without applying an excessive G value to the occupant based on the current vehicle speed as a reference. Since the emergency steering avoidance is an avoidance action with a fairly high risk, it is preferable that motion plan determination unit 12 first considers whether avoidance is possible by braking (emergency stop), and then performs emergency steering avoidance as a last resort.

Motion plan determination unit 12 may use, for example, a known dynamic window approach (see NPTL 3) as a method for calculating the exercise profile of the motion plan.

Motion plan determination unit 12 determines whether to select an “emergency stop motion” or an “emergency steering avoidance motion” as the motion plan based on the distance between vehicle 1 and the rapidly approaching obstacle, the predicted trajectories of both, or information on possible routes around vehicle 1.

Here, motion plan determination unit 12 sequentially updates the motion plan. The update frequency of the motion plan in motion plan determination unit 12 depends on the performance of CPU 10a of control apparatus 10, and is preferably, for example, 10 Hz or more. However, the update frequency of motion plan determination unit 12 is set to be at least higher than the update frequency of trajectory plan determination unit 11. This makes it possible to avoid danger even when an obstacle (i.e., a risk that could not be anticipated when planning the trajectory) suddenly approaches vehicle 1.

Vehicle control unit 13 acquires the motion plan generated by motion plan determination unit 12 and the driving state information of vehicle 1 output from driving state detection device 30. Then, vehicle control unit 13 feedback controls vehicle drive device 20 such that the driving state of vehicle 1 at each time point is in accordance with the determined motion plan.

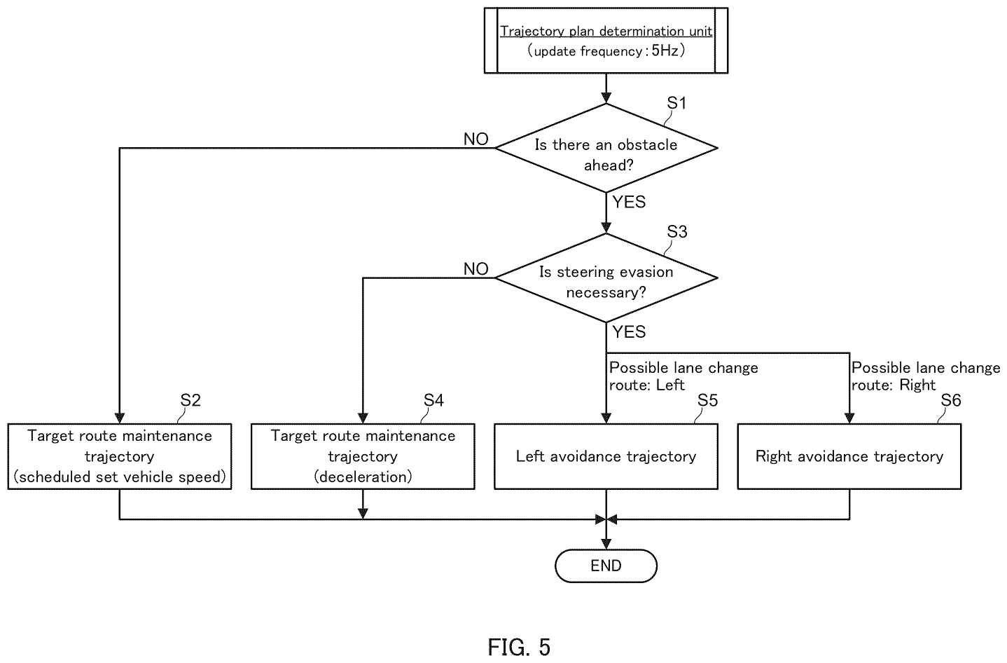

FIG. 5 is a flowchart showing an example of the operation of the trajectory planning unit 11.

In step S1, trajectory plan determination unit 11 first determines whether or not an obstacle exists ahead on the target route based on the surrounding object information. If an obstacle exists ahead (step S1: YES), trajectory plan determination unit 11 proceeds to step S3. On the other hand, if no obstacle exists ahead (step S1: NO), trajectory plan determination unit 11 selects the target route maintaining trajectory as the trajectory plan (step S2). In the target route maintaining trajectory, for example, a trajectory profile of the trajectory plan is set so that vehicle 1 travels on the target route at the scheduled set vehicle speed.

In step S3, trajectory plan determination unit 11 determines whether or not steering avoidance of the obstacle detected in step S1 is necessary when vehicle 1 travels on the target route. At this time, if steering avoidance is not necessary (step S3: NO), trajectory plan determination unit 11 selects the target route maintaining trajectory as the trajectory plan (step S4). Here, if the speed of the obstacle detected in step S1 is sufficiently fast, trajectory plan determination unit 11 does not take unnecessary avoidance action and maintains the target route maintaining trajectory. In addition, trajectory plan determination unit 11 refers to map information 70a, and if lane change is impossible, selects the target route maintaining trajectory as the trajectory plan, and for example, a trajectory profile of the trajectory plan is set so that vehicle 1 decelerates on the target route so as not to collide with the obstacle ahead.

On the other hand, if steering avoidance is necessary (step S3: YES) and map information 70a indicates that a lane change is possible to the left, trajectory plan determination unit 11 selects the left avoidance trajectory as the trajectory plan (step S5). Also, if steering avoidance is necessary (step S3: YES) and map information 70a indicates that a lane change is possible to the right, trajectory plan determination unit 11 selects the right avoidance trajectory as the trajectory plan (step S6). When selecting the left avoidance trajectory or the right avoidance trajectory, trajectory plan determination unit 11 sets a trajectory profile of the trajectory plan based on Trajectory base model 70c so that the movement trajectory from the current position of vehicle 1 to the travelable route becomes appropriate.

Trajectory plan determination unit 11 repeatedly executes the above-mentioned processing at a predetermined interval (here, 5 Hz).

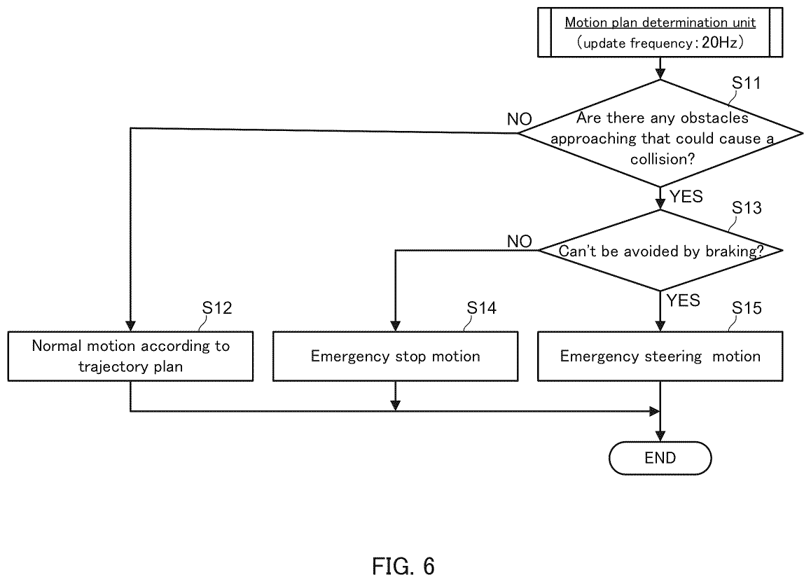

FIG. 6 is a flowchart showing an example of the operation of motion plan determination unit 12.

In step S11, motion plan determination unit 12 first determines whether or not an obstacle that may cause a collision with vehicle 1 is approaching based on the surrounding object information. If an obstacle that may cause a collision is approaching (step S11: YES), motion plan determination unit 12 proceeds to step S13. On the other hand, if an obstacle that may cause a collision is not approaching (step S11: NO), motion plan determination unit 12 selects normal motion as the motion plan (step S12). Note that normal motion means motion according to a trajectory plan, and motion plan determination unit 12 calculates a motion profile of the motion plan (i.e., a target acceleration/deceleration and a target yaw rate at each time point) based on the driving state information of vehicle 1 and the current position information of vehicle 1 so as to satisfy the target traveling position and the target vehicle speed of vehicle 1 at each time point set in the trajectory plan.

In step S13, motion plan determination unit 12 judges whether or not the collision between vehicle 1 and the obstacle detected in step S11 is unavoidable by braking. At this time, if the collision is unavoidable by braking (step S13: NO), motion plan determination unit 12 selects an emergency stop motion as the motion plan (step S14). Note that, when the emergency stop motion is selected, motion plan determination unit 12 disables the currently set trajectory plan, and sets a motion plan for bringing vehicle 1 to an emergency stop at a predetermined deceleration based on motion base model 70d for the “emergency stop motion”.

On the other hand, if the collision cannot be avoided by braking (step S13: YES), motion plan determination unit 12 selects an emergency steering avoidance motion as the motion plan (step S15). At this time, if the travelable route is the right lane with respect to the current position, motion plan determination unit 12 performs emergency steering to the right lane for avoidance. If the travelable route is the right lane with respect to the current position, motion plan determination unit 12 performs emergency steering to the left lane for avoidance. Note that, when the emergency steering avoidance motion is selected, motion plan determination unit 12 disables the currently set trajectory plan, and sets a motion profile for steering avoidance so as to draw a spline curve to the left or right while decelerating vehicle 1 at a predetermined deceleration based on motion base model 70d for “emergency steering avoidance motion”.

Motion plan determination unit 12 repeatedly executes the above-mentioned process at a predetermined interval (here, 20 Hz).

### Effects

As described above, in this embodiment, the control apparatus of the vehicle that automatically travels along a predetermined target route is disclosed, the control apparatus comprising: a trajectory plan determination unit configured to determine, based on surrounding information of the vehicle, which trajectory plan to adopt as a future travel trajectory of the vehicle between a target route maintenance trajectory, a left avoidance trajectory, and a right avoidance trajectory; a motion plan determination unit configured to determine, based on the surrounding information, which motion plan to adopt as a future motion mode of the vehicle between a normal motion according to the determined trajectory plan or an emergency evacuation motion that temporarily disables the determined trajectory plan; and a vehicle control unit configured to control the vehicle based on the motion plan and current driving state information of the vehicle such that the driving state of the vehicle at each future time point is in accordance with the determined motion plan, wherein the trajectory plan determination unit and the motion plan determination unit sequentially update the trajectory plan and the motion plan, respectively, and the update frequency of the motion plan determination unit is higher than the update frequency of the trajectory plan determination unit.

According to the vehicle control apparatus of this embodiment, by using a hierarchical plan, vehicle motion can be sequentially controlled based on a motion plan with a shorter calculation time, rather than a trajectory plan with a longer calculation time. This also enables a robust driving plan, such as a motion plan that can avoid risks that could not be anticipated at the time of trajectory planning. In addition, by implementing a trajectory plan with a longer calculation time at a low cycle and a motion plan with a shorter calculation time at a high cycle, it becomes possible to reduce the calculation load of the control system for autonomous vehicle driving.

Although the specific examples of the present invention have been described in detail above, these are merely examples and do not limit the scope of the claims. The technology described in the claims includes various modifications and changes of the specific examples exemplified above.

This application is entitled to the benefit of U.S. patent application Ser. No. 63/705,132 filed on Oct. 9, 2024 and Japanese Patent Application No. 2025-012996 filed on Jan. 29, 2025, the disclosures of which including the specification, drawings and abstract are incorporated herein by reference in their entirety.

### INDUSTRIAL APPLICABILITY

According to the vehicle control apparatus of the present invention, it is possible to realize robust vehicle control capable of dealing with risks that could not be anticipated during trajectory planning.

### REFERENCE SIGNS LIST

1 Vehicle
10 Control apparatus
11 Trajectory plan determination unit
12 Motion plan determination unit
13 Vehicle control unit
20 Vehicle drive device
30 Driving state detection device
40 Position acquisition device
50 Surrounding information acquisition device
60 HMI (Human Machine Interface)
70 Storage device
70a Map information
70b Traveling schedule information
70c Trajectory base model
70d Motion base model

1. A control apparatus of a vehicle that automatically travels along a predetermined target route, the control apparatus comprising:
a trajectory plan determination unit configured to determine, based on surrounding information of the vehicle, which trajectory plan to adopt as a future travel trajectory of the vehicle between a target route maintenance trajectory, a left avoidance trajectory, and a right avoidance trajectory;
a motion plan determination unit configured to determine, based on the surrounding information, which motion plan to adopt as a future motion mode of the vehicle between a normal motion according to the determined trajectory plan or an emergency evacuation motion that temporarily disables the determined trajectory plan; and
a vehicle control unit configured to control the vehicle based on the motion plan and current driving state information of the vehicle such that the driving state of the vehicle at each future time point is in accordance with the determined motion plan,
wherein the trajectory plan determination unit and the motion plan determination unit sequentially update the trajectory plan and the motion plan, respectively, and the update frequency of the motion plan determination unit is higher than the update frequency of the trajectory plan determination unit.

2. The control apparatus according to claim 1, wherein the trajectory plan includes time-series data relating to a target traveling position and a target vehicle speed at each future time point of the vehicle, and the motion plan includes time-series data relating to a target acceleration/deceleration and a target yaw rate at each future time point of the vehicle.

3. The control apparatus according to claim 1, wherein the trajectory plan determination unit configured to receive inputs of sequentially current driving state information of the vehicle, current position information of the vehicle, and surrounding information of the vehicle, and calculate a trajectory profile of the determined trajectory plan based on these pieces of information, traveling schedule information including the target route and a set vehicle speed, map information, and a trajectory base model of the corresponding trajectory plan.

4. The control apparatus according to claim 3, wherein the trajectory plan determination unit configured to adopt the trajectory plan related to the target route maintaining trajectory when an obstacle is not detected in front of the vehicle in the surrounding information, and when there is no need to steer around the obstacle or when it is not possible to steer around the obstacle,
and adopt the trajectory plan related to the left avoidance trajectory or the right avoidance trajectory when an obstacle is detected in front of the vehicle in the surrounding information, and it is possible to steer around the obstacle and it is necessary to steer around the obstacle.

5. The control apparatus according to claim 1, wherein the motion plan determination unit configured to receive inputs of sequentially detected driving state information of the vehicle, current position information of the vehicle, surrounding information of the vehicle, and information related to the determined trajectory plan, and calculates a motion profile of the determined motion plan based on these pieces of information and a motion base model of the corresponding motion plan.

6. The control apparatus according to claim 1, wherein the motion plan determination unit configured to adopt the motion plan of the normal motion when the surrounding information does not detect the approach of an obstacle that may cause a collision around the vehicle, and adopt the motion plan of the emergency evacuation motion when the surrounding information detects the approach of an obstacle that may cause a collision around the vehicle.

7. The control apparatus according to claim 6, wherein the emergency evacuation motion includes an emergency stop motion and an emergency steering motion, and the motion plan determination unit configured to adopt the motion plan of the emergency stop motion when it is possible to avoid a collision between the vehicle and the obstacle by braking, and adopt the motion plan of the emergency steering motion when it is impossible to avoid a collision between the vehicle and the obstacle by braking.

8. The control apparatus according to claim 4, wherein, when adopting the trajectory plan of the left avoidance trajectory or the right avoidance trajectory, the trajectory plan determination unit configured to identify a travelable route adjacent to the target route based on the surrounding information or the map information, and create the trajectory profile corresponding to the travelable route.

9. The control apparatus according to claim 8, wherein, if the travelable route adjacent to the target route is not identified by the surrounding information and the map information, the trajectory plan determination unit newly plans a corrected target route based on the current vehicle position and a final destination position of the target route to create the trajectory profile.

10. The control apparatus according to claim 1, wherein the trajectory plan determination unit configured to calculate a trajectory profile of the trajectory plan based on a kinematic model of the vehicle.

11. The control apparatus according to claim 1, wherein the motion plan determination unit configured to calculate a motion profile of the motion plan based on a dynamics model of the vehicle.
